(19) United States
(12) Patent Application Publication
(10) Pub. No.: US 2025/0121542 A1
(43) Pub. Date: Apr. 17, 2025

(54) INSERT CHANGEOVER SYSTEM FOR AN INJECTION MOLD

(71) Applicant: CuBE Packaging Solutions Inc., Aurora (CA)

(72) Inventor: Alexander Segal, Richmond Hill (CA)

(21) Appl. No.: 18/912,228

(22) Filed: Oct. 10, 2024

Related U.S. Application Data
(60) Provisional application No. 63/589,917, filed on Oct. 12, 2023.

(51) Int. Cl. B29C 45/26; B29C 45/82

(52) U.S. Cl. CPC B29C 45/2675; B29C 45/82; B29C 2045/822

(57) ABSTRACT

An insert changeover system for an injection mold having a releasably secured insert for quick customizations of the injection mold. The insert changeover system includes a mold body having a pneumatic pull stock clamp and an insert having an insert guide pin. The pneumatic pull stock clamp is configured to releasably secure the insert guide pin when the insert is mounted on the mold body to selectively lock and unlock a position of the insert.

### CROSS-REFERENCE TO RELATED APPLICATION

This Application claims the benefit of U.S. Provisional Application 63/589,917filed on Oct. 12, 2023, the disclosure of which is incorporated herein by reference in its entirety.

### FIELD OF THE INVENTION

The present invention is directed to an insert changeover system for an injection mold, and an injection mold having an insert changeover system, and more particularly, to an insert changeover system having a releasably secured insert, and an injection mold having an insert changeover system, configured to enable quick customizations of an insert of an injection mold.

### BACKGROUND OF THE INVENTION

A conventional injection mold typically requires disassembly of several parts of the injection mold, such as all the layers of the stack, along with removal of retainer bolts (e.g., all of the retainer bolts) in order to remove an insert from the injection mold. Furthermore, a conventional injection mold commonly requires drainage of water from the injection mold, reduction of heat of the injection mold, and/or recalibration of the injection mold in order to remove an insert from the injection mold. As a result, in a conventional injection mold, a step of changing an insert (e.g., inserting, removing, and/or replacing an insert) commonly requires a considerable amount of time, such as a minimum of 45-50minutes, minimum of 45-75 minutes, etc.

### SUMMARY OF THE INVENTION

The exemplary embodiments of the present invention recognize that it is desirable to simplify the way in which an insert of an injection mold can be changed (e.g., inserted, removed, and/or replaced) and to reduce or minimize an amount of time needed for an insert of an injection mold to be changed.

These problems and others are addressed by the present invention, a first exemplary embodiment of which comprises an insert changeover system for an injection mold, and an injection mold having an insert changeover system, having a releasably secured insert configured to enable quick customizations of an insert of an injection mold. The insert changeover system includes a mold body having at least one pneumatic pull stock clamp and an insert having at least one insert guide pin, wherein the at least one pneumatic pull stock clamp is configured to releasably secure the at least one insert guide pin when the insert is mounted on the mold body.

In this way, the exemplary embodiments of the invention can simplify the way in which an insert of an injection mold can be changed (e.g., inserted, removed, and/or replaced) and reduce or minimize an amount of time needed for the insert of the injection mold to be changed. Further, the exemplary embodiment of the invention can allow an insert of an injection mold to be changed without any mold disassembly or water drainage, while at the same time permitting the injection mold to remained in a heated state. According to the exemplary embodiments, the release and changing of an insert of an injection mold can be simply and easily completed in substantially less time than with a conventional injection mold. For example, in some embodiments, the release and changing of an insert of an injection mold according to the invention can be completed within about 1-2 minutes, as compared to a period of approximately 45-50 minutes, 45-75minutes, etc. required to release and change an insert in a conventional injection mold. According to the exemplary embodiments of the invention, an injection mold can be quickly and easily customized, for example to change a branding designation, logo, or other mark, text, or texture, to change a characteristic of a part of the mold cavity (e.g., shape, dimension, etc.), among other things.

By way of example, and not limitation, the insert guide pin can be configured to include a portion, integral part, and/or attachment configured to engage the pneumatic pull stock clamp, such as a pull stock bolt integrally formed with or coupled to a free end of the insert guide pin. The pneumatic pull stock clamp can be configured to releasably secure the pull stock bolt of the insert guide pin. More particularly, the pneumatic pull stock clamp can be configured to selectively lock and unlock a position of the pull stock bolt of the insert guide pin with respect to the pneumatic pull stock clamp.

In an example, a portion of the at least one insert guide pin can be configured to engage the pneumatic pull stock clamp when the insert is mounted on the mold body, and the pneumatic pull stock clamp can be configured to secure the portion of the at least one insert guide pin in a fixed position such that the insert is secured to the mold body.

In another example, the insert can abut a face of the mold body when the insert is mounted on the mold body and the mold body can include a tunnel extending from the face to the pneumatic pull stock clamp. A portion of the insert guide pin extends from the insert through the tunnel to the at least one pneumatic pull stock clamp when the insert is mounted on the mold body.

The pneumatic pull stock clamp can be configured to secure a portion of the insert guide pin in a locked state such that the insert is secured to the mold body. The pneumatic pull stock clamp can be configured to selectively lock and unlock a portion of the insert guide pin within a body of the pneumatic pull stock clamp.

In an example, a body of the pneumatic pull stock clamp includes a release air port. When an air pressure is applied to the release air port, the pneumatic pull stock clamp can be configured to receive a portion of the insert guide pin within the body of the pneumatic pull stock clamp. When the air pressure is not applied to the release air port, the pneumatic pull stock clamp locks the portion of the insert guide pin within the body of the pneumatic pull stock clamp. In an example, the pneumatic pull stock clamp can include a spring lock that locks the portion of the insert guide pin within the body of the pneumatic pull stock clamp when the air pressure is not applied to the release air port. The spring lock can include, for example, one or more springs configured to bias a portion of the pneumatic pull stock clamp into an engaged position with a corresponding portion of the insert guide pin to prevent the insert guide pin from being moved or withdrawn from the pneumatic pull stock clamp. When the air pressure is re-applied to the release air port, the pneumatic pull stock clamp unlocks the portion of the insert guide pin with respect to the body of the pneumatic pull stock clamp.

In another example, a body of the pneumatic pull stock clamp includes a lock air port and a release air port. When an air pressure is applied to the release air port, the pneumatic pull stock clamp can be configured to receive a portion of the insert guide pin within the body of the pneumatic pull stock clamp. When an air pressure is applied to the lock air port, the pneumatic pull stock clamp locks the portion of the insert guide pin within the body of the pneumatic pull stock clamp. When the air pressure is re-applied to the release air port, the pneumatic pull stock clamp unlocks the portion of the insert guide pin with respect to the body of the pneumatic pull stock clamp.

In an example, the mold body includes a mold cavity and the insert is disposed in the mold cavity. The insert can abut a face of the cavity when the insert is disposed in the mold cavity. The mold body can include a tunnel extending from an opening in the face of the mold cavity to the pneumatic pull stock clamp. In this example, at least a portion of the insert guide pin extends from the insert into the opening and through the tunnel to the pneumatic pull stock clamp when the insert is disposed in the mold cavity.

In another example, the mold body includes a plurality of module plates, and the pneumatic pull stock clamp is accommodated within the plurality of module plates.

In some examples, the injection mold includes a plurality of pneumatic pull stock clamps and a plurality of insert guide pins. Preferably, the injection mold includes two pneumatic pull stock clamps and two corresponding insert guide pins, and more preferably, four pneumatic pull stock clamps and four corresponding insert guide pins. In some examples, each of the pneumatic pull stock clamps and the insert guide pins are disposed adjacent a corner of a cavity of the mold body.

Another exemplary embodiment is directed to an injection mold system including an injection mold having a mold body having at least one pneumatic pull stock clamp and an insert having at least one insert guide pin, wherein the at least one pneumatic pull stock clamp is configured to releasably secure the at least one insert guide pin when the insert is mounted on the mold body, and wherein a body of the pneumatic pull stock clamp includes a release air port. The system can include an air line coupled to the release air port of the pneumatic pull stock clamp and configured to supply air pressure to the release air port.

Another exemplary embodiment is directed to an injection mold system including an injection mold having a mold body having at least one pneumatic pull stock clamp and an insert having at least one insert guide pin, wherein the at least one pneumatic pull stock clamp is configured to releasably secure the at least one insert guide pin when the insert is mounted on the mold body, and wherein a body of the pneumatic pull stock clamp includes a lock air port and a release air port. The system includes a first air line coupled to the release air port of the pneumatic pull stock clamp and configured to supply air pressure to the release air port, and a second air line coupled to the lock air port of the pneumatic pull stock clamp and configured to supply air pressure to the lock air port.

Another exemplary embodiment is directed to a method of releasably securing an insert of an injection mold, wherein the injection mold includes a mold body having at least one pneumatic pull stock clamp and an insert having at least one insert guide pin, wherein the at least one pneumatic pull stock clamp is configured to releasably secure the at least one insert guide pin when the insert is mounted on the mold body. The method includes applying air pressure to a release air port of a body of the pneumatic pull stock clamp, inserting a portion of the insert guide pin within the body of the pneumatic pull stock clamp, and turning off the air pressure to the release air port to lock the portion of the insert guide pin within the body of the pneumatic pull stock clamp. The method further includes re-applying the air pressure to the release air port to unlock the portion of the insert guide pin with respect to the body of the pneumatic pull stock clamp, and removing the insert guide pin with respect to the body of the pneumatic pull stock clamp to remove the insert from the injection mold.

Another exemplary embodiment is directed to a method of releasably securing an insert of an injection mold, wherein the injection mold includes a mold body having at least one pneumatic pull stock clamp and an insert having at least one insert guide pin, wherein the at least one pneumatic pull stock clamp is configured to releasably secure the at least one insert guide pin when the insert is mounted on the mold body. The method includes applying air pressure to a release air port of a body of the pneumatic pull stock clamp, inserting a portion of the insert guide pin within the body of the pneumatic pull stock clamp, and turning off the air pressure to the release air port to lock the portion of the insert guide pin within the body of the pneumatic pull stock clamp. The method further includes re-applying the air pressure to the release air port to unlock the portion of the insert guide pin with respect to the body of the pneumatic pull stock clamp, and removing the insert guide pin with respect to the body of the pneumatic pull stock clamp to remove the insert from the injection mold.

In another example, a body of the pneumatic pull stock clamp includes a lock air port and a release air port. The method includes applying air pressure to a release air port of a body of the pneumatic pull stock clamp, inserting a portion of the insert guide pin within the body of the pneumatic pull stock clamp. In this example, the method includes applying an air pressure to the lock air port to lock the portion of the insert guide pin within the body of the pneumatic pull stock clamp. The method further includes re-applying the air pressure to the release air port to unlock the portion of the insert guide pin with respect to the body of the pneumatic pull stock clamp, and removing the insert guide pin with respect to the body of the pneumatic pull stock clamp to remove the insert from the injection mold.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a partial, exploded perspective view of an insert changeover system for an injection mold according to an exemplary embodiment of the invention;

FIG. 2 is another partial, exploded perspective view of an insert changeover system for an injection mold according to an exemplary embodiment of the invention;

FIG. 3 is a partial, perspective view of an insert changeover system for an injection mold according to an exemplary embodiment of the invention;

FIG. 4 is a top view of a part of an insert changeover system for an injection mold according to an exemplary embodiment of the invention;

FIG. 5 is another top view of the part of the insert changeover system for an injection mold of FIG. 4;

FIG. 6 is a top view of another part of an insert changeover system for an injection mold according to an exemplary embodiment of the invention;

FIG. 7 is another top view of the part of the insert changeover system of FIG. 6;

FIG. 8 is an exploded cross-sectional view of an insert changeover system for an injection mold according to an exemplary embodiment of the invention;

FIG. 9 is a cross-sectional view of the assembled insert changeover system of FIG. 8;

FIG. 10A is a side view of an insert guide pin according to an exemplary embodiment of the invention;

FIG. 10B is an exploded view of an insert guide pin and pull stock clamp assembly of an insert changeover system for an injection mold according to an exemplary embodiment of the invention;

FIG. 10C is an assembled view of an insert guide pin and pull stock clamp assembly of FIG. 10B;

FIG. 10D is a side view of a pull stock bolt of an insert guide pin according to an exemplary embodiment of the invention;

FIG. 10E is a top view of a pull stock clamp of an insert changeover system for an injection mold according to an exemplary embodiment of the invention;

FIG. 11A is an exploded view of an insert guide pin and pull stock clamp assembly of an insert changeover system for an injection mold according to another exemplary embodiment of the invention; and

FIG. 11B is an assembled view of an insert guide pin and pull stock clamp assembly of FIG. 11A.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

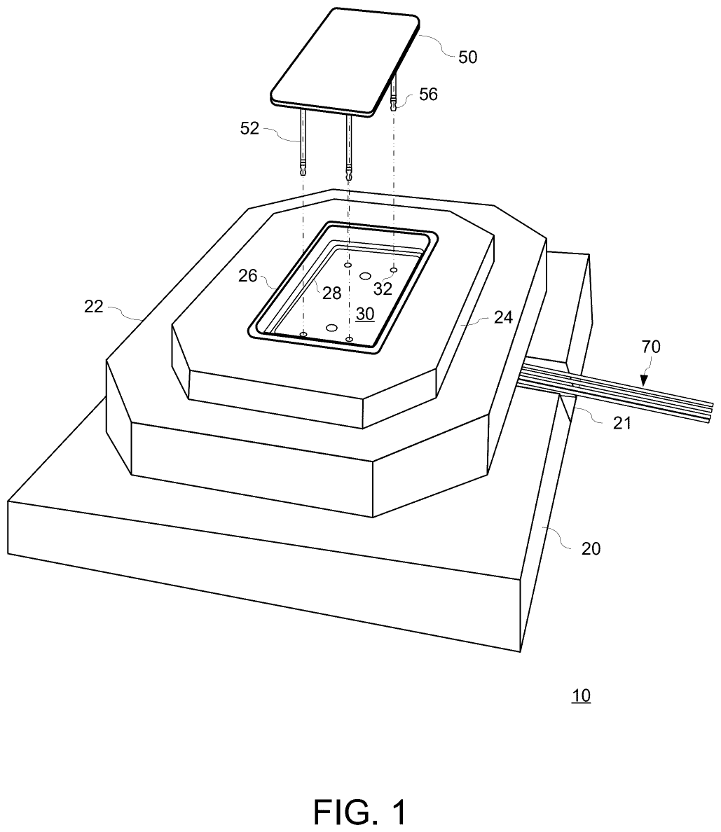

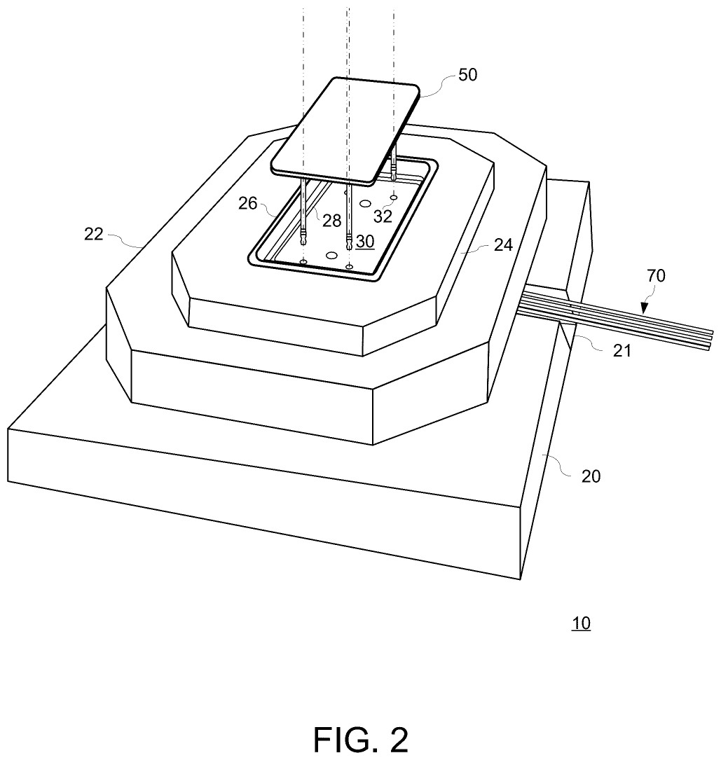

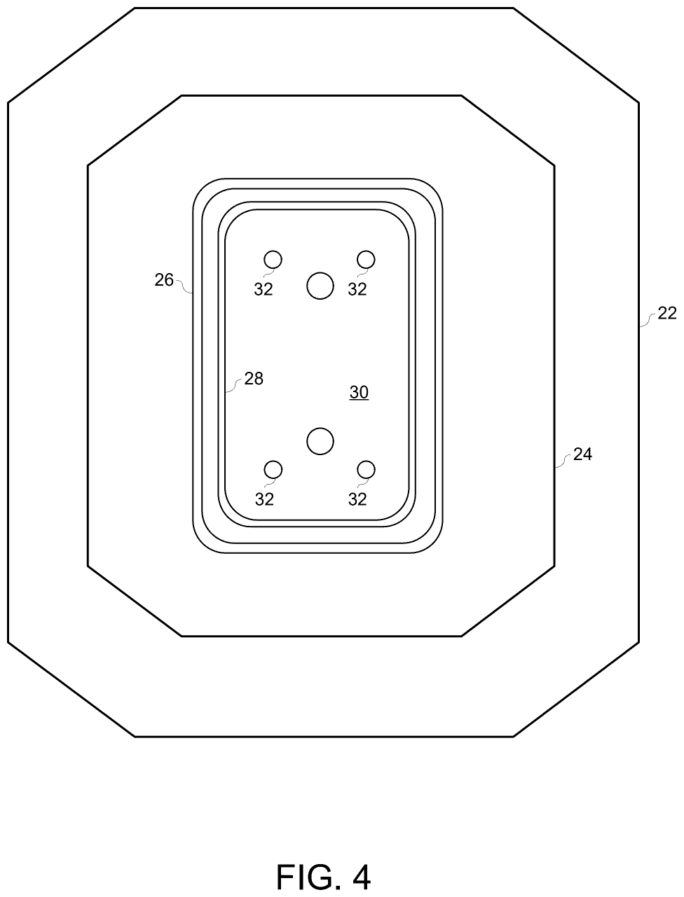

Referring now to the drawings, FIGS. 1-11B illustrate exemplary embodiments of an insert changeover system for an injection mold having a releasably secured insert.

With reference to FIGS. 1-8, examples of an insert changeover system 10 for an injection mold can include a mold body. In the illustrated example, the mold body can be formed from one or more parts configured to form one or more injection molded parts by forcing molten resin into one or more mold cavities under pressure. By way of example and not limitation, the insert changeover system 10 can include a plurality of module plates (e.g., 20, 22, 24) forming a cavity side of the injection mold, as shown in the illustrated examples. One or more plates (e.g., 80) can be provided to form a core side of the injection mold. The mold body is not limited to any particular size, shape, arrangement, and/or number of parts and can be configured to cooperate with one or more additional components to produce one or more parts suitable for injection molding. For illustrative purposes, the features of the insert changeover system 10 have been shown schematically. Various features of the insert changeover system 10 and the injection mold, such as liquid/water or air cooling circuits, air vents, material injection circuits, gates, etc., ejector, guide, and/or clamping parts, and/or other features of the parts of the injection mold have been omitted for clarity. One of ordinary skill in the art will recognize that these features are contemplated by the present invention.

With reference again to FIGS. 1-8, the exemplary insert changeover system 10 for an injection mold includes a releasably secured insert 50. The insert 50 includes a body that forms a part of the injection mold, such as a surface of the mold cavity, configured to be customized. The body can include, for example, a plate or the like. The insert 50 is not limited to any particular size, shape, and/or arrangement. The insert changeover system 10 is configured such that the insert 50 can be changed (e.g., inserted, removed, and/or replaced) with respect to the mold body to provide customization of the injection mold. For example, the insert 50 can be configured to include customize branding, logos, notices, instructions, or other text, images, and/or symbols, a textured surface or surface portion, and/or other features to produce a customized injection molded part. Other arrangements of the insert 50 are possible within the spirit and scope of the invention.

According to the exemplary embodiments, an insert changeover system 10 having a releasably secured insert 50 can be provided independent of, isolated from, and/or without affecting or necessitating disassembly, drainage, etc. of, such other features, such as liquid/water or air cooling circuits, air vents, material injection circuits, gates, etc., ejector, guide, and/or clamping parts, and/or other features of the parts of the injection mold. In this way, the exemplary embodiments of the invention can simplify the way in which an insert of an injection mold can be changed (e.g., inserted, removed, and/or replaced) and reduce or minimize an amount of time needed for the insert of the injection mold to be changed. Further, the exemplary embodiment of the invention can allow an insert of an injection mold to be changed without any mold disassembly or water drainage, while at the same time permitting the injection mold to remained in a heated state.

As shown in FIGS. 1-5, the mold body forms a mold cavity 26 configured to form an injection molded part. In this example, the mold cavity 26 is configured to form a top of a food storage container. The mold cavity 26 is configured to receive the insert 50 therein. In an example, the mold cavity 26 includes a recess 28 forming a recessed surface 30 for receiving and accommodating the insert 50 therein. In this way, when an insert 50 is inserted into (or replaced in) the recess 28, the insert 50 can be configured to form a part of a surface of the mold cavity 26. The recess 28 and recessed surface 30 can be configured to substantially correspond to a portion of the insert 50, such as a size and shape of a body portion of the insert 50. In this way, the insert 50 can be configured to form (e.g., integrally and/or seamlessly form) a part of a surface of the mold cavity 26.

Referring again to FIGS. 1-5, the insert 50 can include one or more insert guide pins 52 extending from a side of the insert 50 facing the mold cavity 26 when the insert 50 is inserted into the mold cavity 26. Features of the insert guide pins 52 will be described in greater detail below.

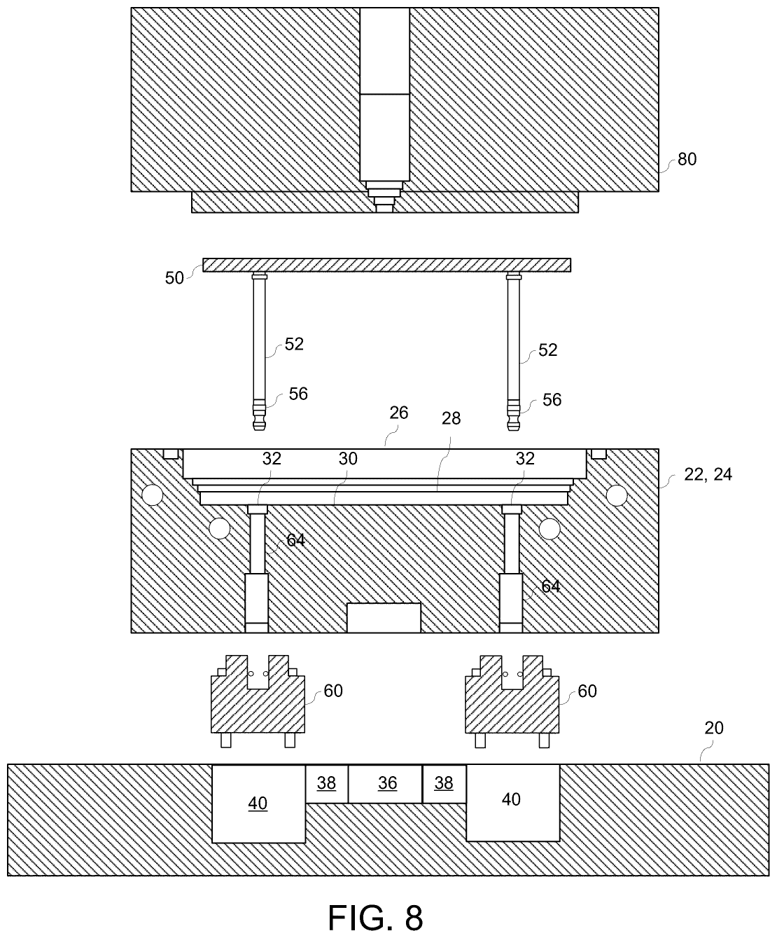

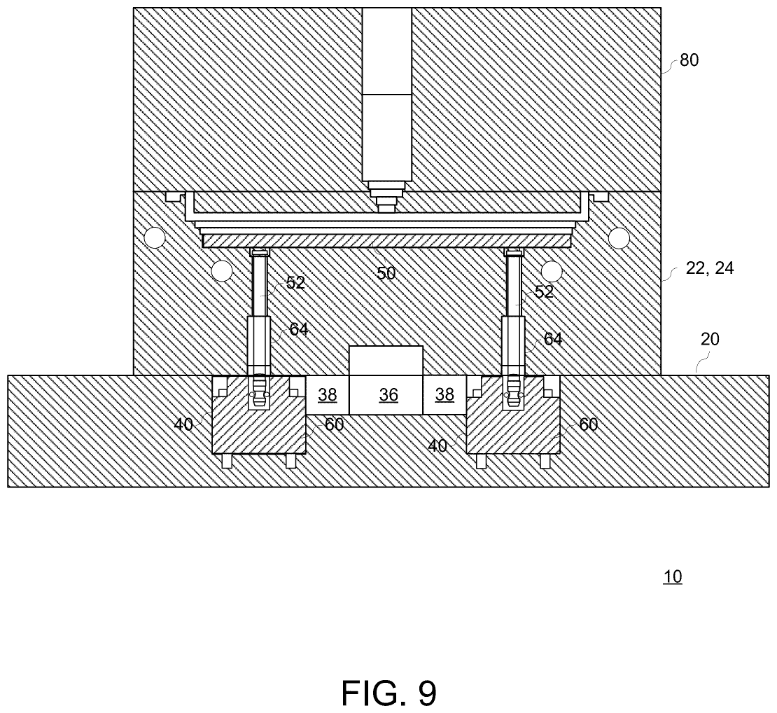

As shown in FIGS. 1, 2, and 4, the recessed surface 30 of the mold cavity 26 includes one or more openings 32. The size, shape, and position of each of the openings 32 are configured to correspond to and align with each of the insert guide pins 52 of the insert 50. In this example, each of the openings 32 is disposed adjacent to an edge or corner of the recessed surface 30 of the mold cavity 26 when viewed in plan view from a front side of the mold stack. However, in other examples, the mold body can include one opening 32, two openings 32, four openings 32, six openings 32, etc., or other amounts and arrangements of openings 32 depending on the configuration of the mold cavity 26, insert 50, etc. of the injection mold. The mold body includes one or more corresponding tunnels 64 (e.g., one or more cylindrical tunnels, described with reference to FIGS. 8 and 9 below) accessible via the openings 32 in the recessed surface 30. Each of the tunnels 64 is configured to receive a corresponding insert guide pin 52 of the insert 50 as the insert 50 is inserted into the mold cavity 26.

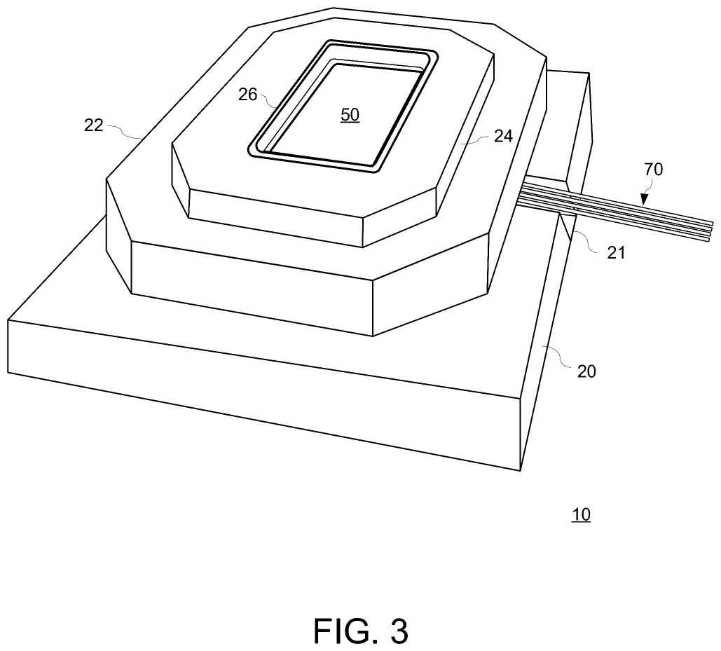

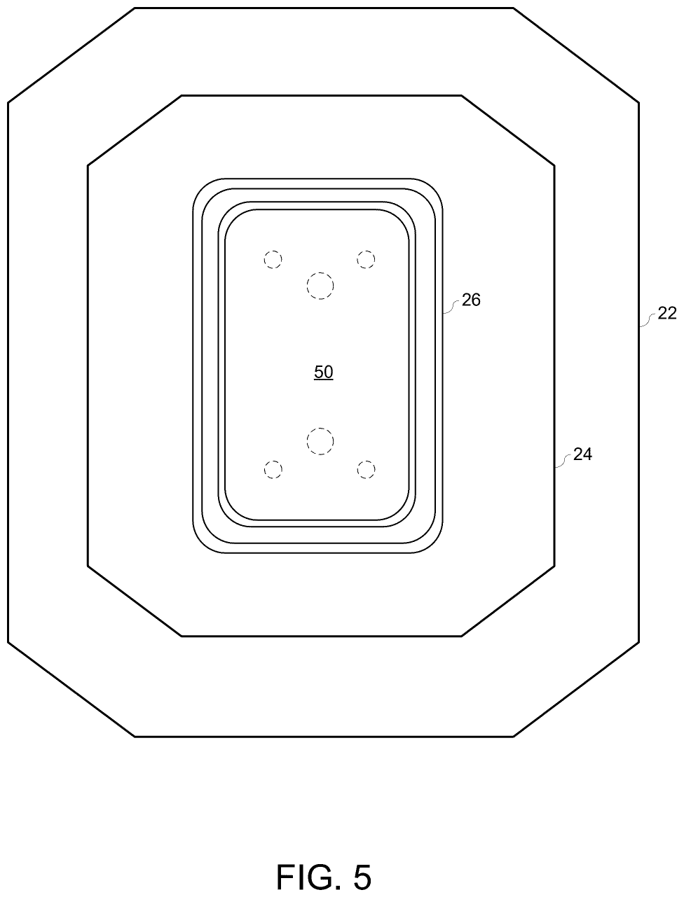

As shown in FIGS. 3 and 5, when the insert 50 is inserted into (or replaced in) the mold cavity 26, and more particularly, in the recess 28, the insert 50 can be configured to form a part of a surface of the mold cavity 26. In this example, the insert 50 covers (e.g., substantially or completely covers) the recess surface 30 to form (e.g., integrally and/or seamlessly form) a face of the mold cavity 26. The insert guide pins 52 of the insert 50, openings 32, and recess surface 30 are separated or isolated from the mold cavity 26 by the body of the insert 50.

As will be explained, the insert changeover system 10 is configured to include one or more pneumatic pull stock clamps 60 configured to releasably secure (e.g., to lock and unlock) the insert guide pins 52 of the insert 50. More particularly, the pneumatic pull stock clamps 60 can be configured such that the insert 50 can be inserted into the mold cavity 26, locked in a fixed position, and/or unlocked for removal/replacement of the insert 50.

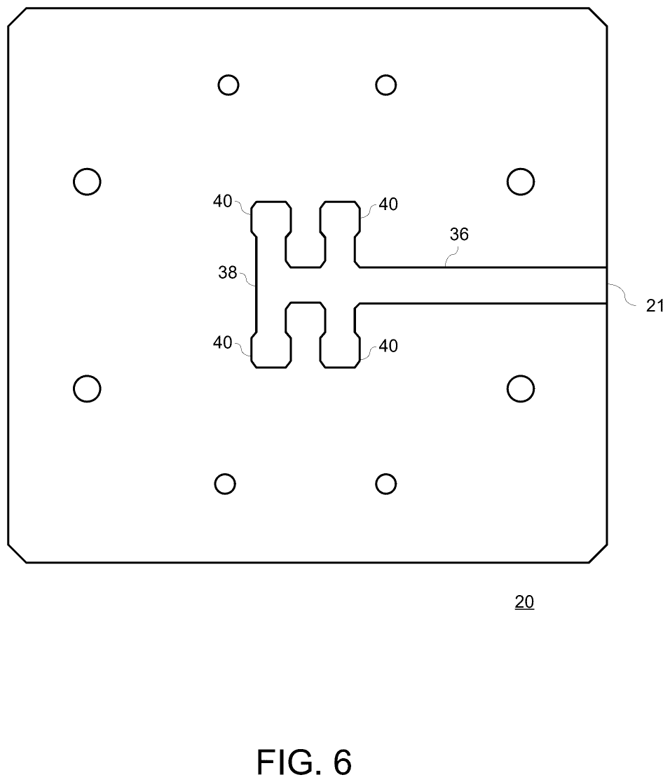

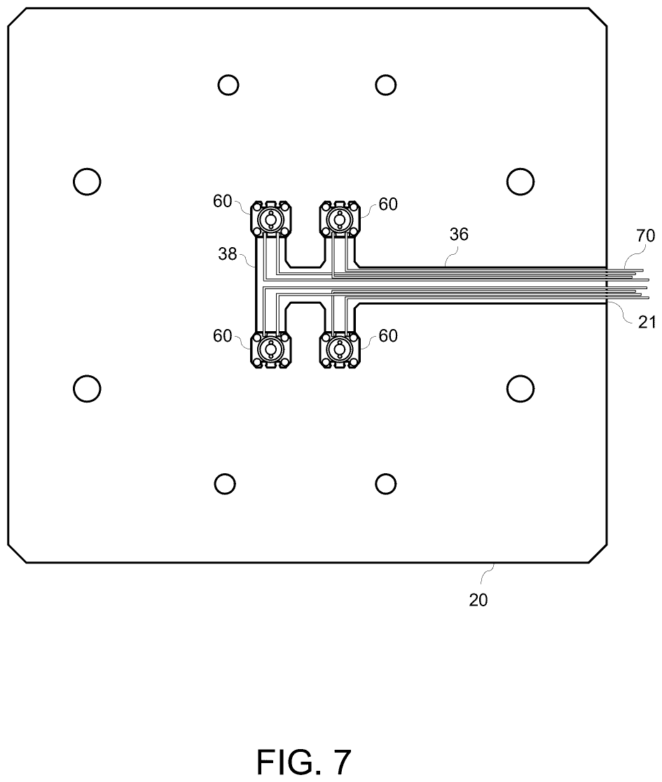

With reference to FIGS. 6-9, the recessed surface 30 of the mold cavity 26 includes one or more openings 32 in communication with one or more tunnels 64 (e.g., one or more cylindrical tunnels). Each of the tunnels 64 extends from the opening 32 in the recessed surface 30 to a corresponding pneumatic pull stock clamp 60, and more particularly, to an opening in a pneumatic pull stock clamp 60 configured to releasably secure a part of each insert guide pin 52 of the insert 50 when the insert 50 is in an inserted state within the mold cavity 26. The pneumatic pull stock clamps 60 can be integrated into or coupled with a part of the mold body, such as a module plate 20 of the mold body. The mold body, and more particularly a module plate 20 of the mold body, can include one or more openings, receptacles, or the like 40 configured to receive and secure each pneumatic pull stock clamp 60 in a predetermined position and alignment with each respective tunnel 64. In the example illustrated in FIGS. 6 and 7, the module plate 20 includes four openings, receptacles, or the like 40 configured to receive four pneumatic pull stock clamps 60. When the module plate 20 is assembled with the other module plates (e.g., 22, 24) of the mold stack, the four pneumatic pull stock clamps 60 are positioned and aligned with the four tunnels 64 in module plates 22, 24 of the mold stack. In other examples, the module plate 20 can be configured to accommodate one pneumatic pull stock clamp 60, two pneumatic pull stock clamps 60, four pneumatic pull stock clamps 60, six pneumatic pull stock clamps 60, etc., or other amounts and arrangements of pneumatic pull stock clamps 60 depending on the configuration of the components of the injection mold, such as a size and shape of the mold cavity 26, the number of tunnels 64, etc.

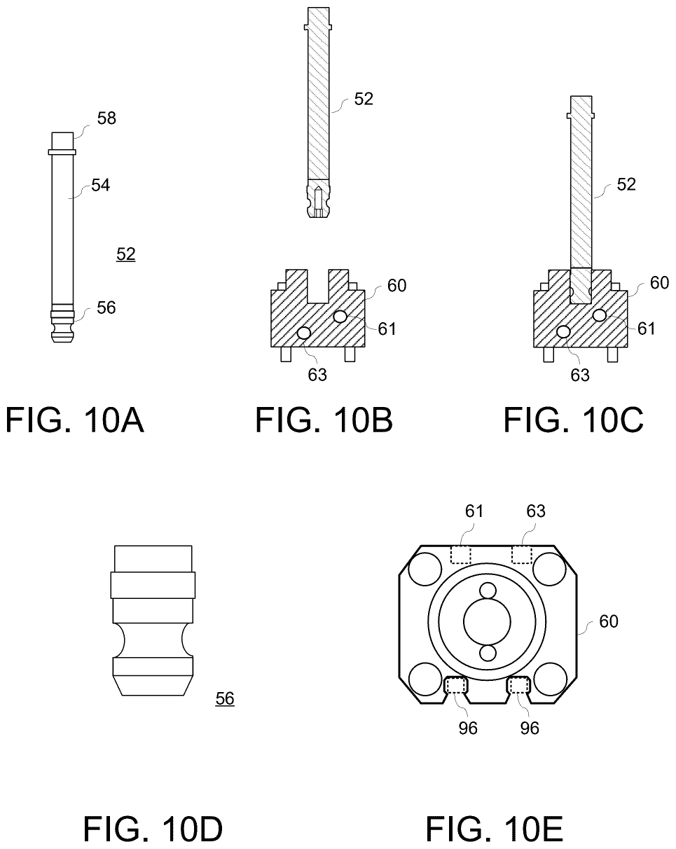

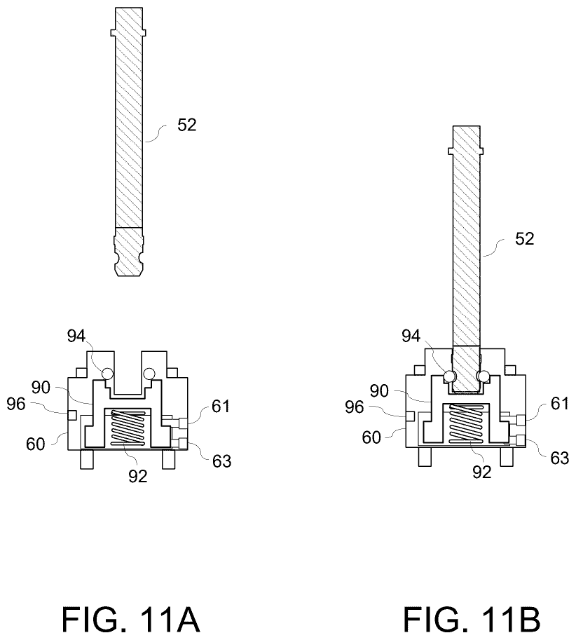

As shown in the example illustrated in FIGS. 6 and 7, the module plate 20 can include one or more air supply cavities (e.g., 36, 38) having one or more downstream ends arranged in communication with one or more air ports 61, 63 of each pneumatic pull stock clamp 60 for supplying air pressure to the one or more air ports (e.g., 61, 63 described with reference to FIGS. 10A-11B) of the pneumatic pull stock clamp 60. The one or more air supply cavities are not limited to any particular arrangement. The one or more air supply cavities 36, 38 can include one or more upstream ends arranged in communication with one or more openings 21, for example, on an exterior of the mold body, in this example the exterior of the module plate 20. The one or more air supply cavities 36, 38 can be configured to receive one or more air lines 70 for supplying air pressure to an air port of the pneumatic pull stock clamp 60. For example, the air lines can be 4 mm diameter air lines. In some examples, the module plate 20 can include a dedicated air supply cavity for supplying air pressure to each pneumatic pull stock clamp 60, or as shown in the illustrated example in FIGS. 6 and 7, a common or interconnected air supply cavity (e.g., 36, 38) can be provided for supplying air pressure to one or more air ports of each of the pneumatic pull stock clamps 60. In the illustrated example, a first air supply cavity 36 extends from the opening 21 in the exterior surface of the module plate 20 towards the pneumatic pull stock clamp 60. One or more second air supply cavities 38, such as one or more branches, a manifold, or the like, can be provided in fluid communication with the first air supply cavity 36 and a plurality of the pneumatic pull stock clamp 60.

The air supply cavities (e.g., 36 and/or 38) are configured to accommodate one or more air lines for supplying air pressure to the ports of the pneumatic pull stock clamp 60. In the example illustrated in FIGS. 6 and 7, one or more air lines 70 extend from an exterior of the mold body through the opening 21 and through the air supply cavities 36, 38, where an end of the air lines 70 is coupled to one of the air ports 61 and/or 63 of each pneumatic pull stock clamp 60. A single air line 70 can be provided for each air port or a common or interconnected air line (not shown) can be provided to supply air pressure to a plurality of air ports at the same time (e.g., to a plurality of air ports 61, or a plurality of air ports 63) via an air distribution manifold or the like. In other examples, the module plate 20 can include one or more integral air lines, each configured to have an air line 70 coupled at an upstream end. The integral air lines can be configured such that an air port of a pneumatic pull stock clamp 60 is coupled (e.g., placed in a fluidly coupled state) with the air port when the pneumatic pull stock clamp 60 is inserted into or positioned within a receptacle 40. The module plate 20 can include one or more couplings or other connectors at the upstream end and/or downstream end for this purpose.

In other examples, the air supply cavities (e.g., 36 and/or 38) also are configured to accommodate one or more signal lines coupled to one or more sensors (not shown), such as a cylinder sensor for confirming action of the pneumatic pull stock clamp 60 and providing closed loop feedback regarding the locked or unlocked state of the pneumatic pull stock clamps 60.

With reference to FIGS. 10A-11B, examples of a pull stop assembly including an insert guide pin 52 and a pneumatic pull stock clamp 60 will now be described.

FIG. 10A illustrates an example of an insert guide pin 52. The insert guide pin 52 includes a longitudinal body 54 having, for example, a cylindrical cross-section. The body 54 can have other cross-sectional shapes, such as a square, rectangular, hexagonal, oval shape or another shape. The insert guide pin 52 includes a portion, integral part, or attachment configured to engage the pneumatic pull stock clamp 60, such as a pull stock bolt 56 (shown in FIG. 10D) integrally formed with or coupled to a free end of the insert guide pin configured to be engaged and retained (e.g., locked) by components of the pneumatic pull stock clamp 60. The engagement portion of the insert guide pin 52 is not limited to the illustrated example and other arrangements are possible. For example, the free end of the insert guide pin 52 can include one or more projections, notches, channels, tapers, or other features configured to be engaged and retained (e.g., locked) by one or more components of the pneumatic pull stock clamp 60.

The insert guide pin 52 further includes a base 58 configured to be coupled on a part of the insert 50, for example, by inserting the base 58 into an opening in a surface of the insert 50. For example, the base 58 can include a threaded portion configured to engage a corresponding internal threaded portion of an opening in the insert 50. In the illustrated example, the free end of the insert guide pin 52 can be configured to be engaged by a tool for threading the base 58 of the insert guide pin 52 into an opening in the insert 50. For example, the pull stop bolt 56 of the insert guide pin 52 can include an integrally formed hex bolt head, Torx head, or other tool mating feature. A size and configuration (e.g., length, diameter, etc.) of the insert guide pin 52 can be configured based on the configuration of the injection mold.

In the illustrated examples, an example of a pneumatic pull stock clamp 60 includes a body having an opening at a top enabling at least a portion of the pull stop bolt 56 of the insert guide pin 52 to be inserted into the pneumatic pull stock clamp 60. In the examples, the pneumatic pull stock clamp 60 includes a release air port 61. An air line 70, as shown in FIGS. 1-3 and 7, can be coupled to the release air port of the pneumatic pull stock clamp 60 for supplying air pressure to the release air port 61 and controlling (e.g., initiating or maintaining) an unlocked state of the pneumatic pull stock clamp 60. In another example, each pneumatic pull stock clamp 60 includes a release air port 61 and a lock air port 63. In this example, a first air line 70 can be provided for supplying air pressure to a release air port 61 of the pneumatic pull stock clamps 60 and a second air line 70 can be provided for supplying air pressure to the lock air port 63 of the pneumatic pull stock clamp 60.

As shown in FIGS. 11A and 11B, an exemplary pneumatic pull stock clamp 60 can be configured such that, when air pressure is applied to the release air port 61, a locking device, locking actuator, or the like 90 is moved (e.g., forced) by the air pressure into an unlocked state that permits or enables the pull stop bolt 56 of the insert guide pin 52 to be inserted by a predetermined distance into the opening in the body of the pneumatic pull stock clamp 60. In the unlocked state, the pull stop bolt 56 of the insert guide pin 52 can pass unimpeded or with a low amount of resistance into the interior of the pneumatic pull stock clamp 60. After the pull stop bolt 56 of the insert guide pin 52 is inserted into the pneumatic pull stock clamp 60, the air pressure can be turned off such that air pressure is not applied to the release air port 61, thereby permitting the locking actuator 90 to move into or return to an original position. As a result, one or more components of the pneumatic pull stock clamp 60 can be caused to engage a portion of the pull stop bolt 56 of the insert guide pin 52, thereby interfering with a movement of the pull stop bolt 56 and locking a position of the pull stop bolt 56 within the body of the pneumatic pull stock clamp 60. For example, the pneumatic pull stock clamp 60 can include a locking actuator 90 and/or other components 94 configured to engage a portion of the pull stop bolt 56, such as one or more of a bearing, tumbler, taper, projection, or the like, configured to engage a portion of the pull stop bolt 56, such as an annular groove, channel, notch, lip, tab, projection, or the like, thereby interfering with a movement of the pull stop bolt 56 at least in a direction extending along a longitudinal length of the body 54 of the insert guide pin 52 and thereby locking a position of the pull stop bolt 56 within the body of the pneumatic pull stock clamp 60.

In an example, the pneumatic pull stock clamp 60 can include a spring lock assembly having one or more springs 92 that bias the locking actuator 90 and/or other components 94 in a locked state. In this example, the pneumatic pull stock clamp 60 is configured to default to a locked state when air pressure is not applied to the release air port 61.

In another example, the pneumatic pull stock clamp 60 includes a release air port 61 and a lock air port 63. In this case, a first air line 70 can be provided for supplying air pressure to a release air port 61 of the pneumatic pull stock clamps 60 and a second air line 70 can be provided for supplying air pressure to the lock air port 63 of the pneumatic pull stock clamp 60. The pneumatic pull stock clamp 60 can be configured such that, when air pressure is applied to the lock air port 63, the locking device, locking actuator, or the like 90 is moved (e.g., forced) by the air pressure into a locked state that prevents or restricts the pull stop bolt 56 from being withdrawn from the body of the pneumatic pull stock clamp 60. In some examples, the step of locking the pneumatic pull stock clamp 60 by supplying air pressure to the lock air port 63 can supplemented by the locking force provided by one or more springs 92, which bias the locking actuator 90 and/or other components 94 of the locking assembly in a locked state. Alternatively, the pneumatic pull stock clamp 60 can be provided without a spring 92 and the step of locking the pneumatic pull stock clamp 60 can be actuated (e.g., solely actuated) by supplying air pressure to the lock air port 63.

According to the exemplary embodiments, a pneumatic pull stock clamp 60 can be configured to releasably secure the pull stop bolt 56 of the insert guide pin 52, thereby enabling the pneumatic pull stock clamp 60 to selectively lock and unlock a position of the pull stop bolt 56 of the insert guide pin 52 with respect to the pneumatic pull stock clamp 60.

In other examples, one or more sensors, signal wiring, or the like, such as one or more cylinder sensors 96 shown in FIGS. 10E-11B, can be provided to monitor or confirm action of the pneumatic pull stock clamps 60 and provide closed loop feedback regarding the locked or unlocked state of the pneumatic pull stock clamps 60. The corresponding signal wiring can be routed and/or accommodated within the one or more air supply cavities 36, 38 or other cavities to extend from the pneumatic pull stock clamps 60 to the exterior of the injection mold 10.

With reference again to FIGS. 1-9, exemplary methods of releasably securing an insert 50 in an injection mold having an insert changeover system 10 will now be described.

In operation, prior to inserting an insert 50 into an injection mold, air pressure is applied to the release air port 61 of the pneumatic pull stock clamp 60 to unlock the pneumatic pull stock clamp 60 and enable it to receive the pull stop bolt 56 of the insert guide pin 52 within the body of the pneumatic pull stock clamp 60. The insert 50 can be positioned and inserted into the mold cavity 26 such that the insert guide pin 52 align with the openings 32 in the recessed surface 30. The insert guide pins 52 can then be inserted into the openings 32 and through the tunnels 64 until the pull stop bolts of the insert guide pins 52 are received within the corresponding pneumatic pull stock clamps 60. A tool, such as a magnetic tool, gripping tool, or the like configured to engage and hold a front surface of the insert 50, can be used for this purpose such that a technician can manipulate and position the insert 50 during this process without interfering with the insertion of the insert guide pins 52 into the openings 32. In some examples, an insulated tool can be provided to minimize heat transfer to the technician when the injection mold is in a heated state. As the insert 50 is positioned in the mold cavity 26, the pull stop bolts of the insert guide pins 52 are inserted into the pneumatic pull stock clamp 60.

In one embodiment, after the pull stop bolts 56 are inserted into the pneumatic pull stock clamp 60 and the insert 50 is positioned in the mold cavity 26, the air pressure can be turned off such that air pressure is not applied to the release air port 61 and the pneumatic pull stock clamp 60 locks the portion of the pull stop bolt 56 within the body of the pneumatic pull stock clamp 60. In an example, the pneumatic pull stock clamp 60 can include a spring lock assembly having spring 92 that biases a position of one or more components (e.g., 90, 94, etc.) of the pneumatic pull stock clamp 60 within the body of the pneumatic pull stock clamp 60. In this example, the insert changeover system 10 can be configured such that a default state of the pneumatic pull stock clamp 60, when air pressure is not applied, is a locked state. As a result, if air pressure is cut off unexpectedly or unintentionally, the exemplary embodiment defaults to a locked position in which the insert 50 is locked and prevented from being removed from the mold cavity 26. In another example in which the pneumatic pull stock clamp 60 includes a release air port 61 and a lock air port 63, air pressure can be supplied to the lock air port 63 to move or force the locking device, locking actuator, or the like (e.g., 90, 94) into the locked state and preventing the pull stop bolt 56 of the insert guide pin 52 from being withdrawn from the body of the pneumatic pull stock clamp 60.

In operation, to remove an insert 50 from the insert changeover system 10, air pressure is applied (or re-applied) to the release air port 61 of the pneumatic pull stock clamp 60 to unlock the pneumatic pull stock clamp 60 and enable the pull stop bolt 56 of the insert guide pin 52 to be withdrawn from the body of the pneumatic pull stock clamp 60. The insert 50 then be withdrawn from the mold cavity 26 by lifting the insert guide pins 52 out of the tunnels 64 and openings 32 in the recessed surface 30. A tool, such as a magnetic tool, gripping tool, or the like configured to engage and hold a front surface of the insert 50, can be used for this purpose such that a technician can manipulate and position the insert 50 during this process without interfering with the insertion of the insert guide pins 52 into the openings 32. In some examples, an insulated tool can be provided to minimize heat transfer to the technician when the injection mold is in a heated state.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element is referred to as being “on”, “attached” to, “connected” to, “coupled” with, “contacting”, etc., another element, it can be directly on, attached to, connected to, coupled with or contacting the other element or intervening elements may also be present. It will also be appreciated by those of skill in the art that references to a structure or feature that is disposed “adjacent” another feature may have portions that overlap or underlie the adjacent feature.

Spatially relative terms may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees or at other orientations) and the descriptors of relative spatial relationships used herein interpreted accordingly.

1. An insert changeover system for an injection mold comprising:
a mold body having at least one pneumatic pull stock clamp; and
an insert having at least one insert guide pin,
wherein the at least one pneumatic pull stock clamp is configured to releasably secure a portion of the at least one insert guide pin when the insert is mounted on the mold body.

2. The insert changeover system of claim 1, wherein the at least one insert guide pin includes a body and a pull stock bolt at a free end of the body, and
wherein the at least one pneumatic pull stock clamp is configured to releasably secure the pull stock bolt to selectively lock and unlock a position of the pull stock bolt with respect to the at least one pneumatic pull stock clamp.

3. The insert changeover system of claim 1, wherein a portion of the at least one insert guide pin is configured to engage the at least one pneumatic pull stock clamp when the insert is mounted on the mold body, and
wherein the at least one pneumatic pull stock clamp is configured to secure the portion of the at least one insert guide pin in a fixed position such that the insert is secured to the mold body.

4. The insert changeover system of claim 1, wherein a part of the insert abuts a face of the mold body when the insert is mounted on the mold body,
wherein the mold body includes a tunnel extending from the face to the at least one pneumatic pull stock clamp, and
wherein at least a portion of the at least one insert guide pin extends from the insert through the tunnel to the at least one pneumatic pull stock clamp when the insert is mounted on the mold body.

5. The insert changeover system of claim 1, wherein the at least one pneumatic pull stock clamp is configured to secure a portion of the at least one insert guide pin in a locked state such that the insert is secured to the mold body.

6. The insert changeover system of claim 1, wherein the at least one pneumatic pull stock clamp is configured to selectively lock and unlock a portion of the at least one insert guide pin within a body of the at least one pneumatic pull stock clamp.

7. The insert changeover system of claim 1, wherein a body of the at least one pneumatic pull stock clamp includes a release air port.

8. The insert changeover system of claim 7, wherein, when an air pressure is applied to the release air port, the at least one pneumatic pull stock clamp is configured to receive a portion of the at least one insert guide pin within the body of the at least one pneumatic pull stock clamp.

9. The insert changeover system of claim 8, wherein, when the air pressure is not applied to the release air port, the at least one pneumatic pull stock clamp locks the portion of the at least one insert guide pin within the body of the at least one pneumatic pull stock clamp.

10. The insert changeover system of claim 9, wherein the at least one pneumatic pull stock clamp includes a spring lock that locks the portion of the at least one insert guide pin within the body of the at least one pneumatic pull stock clamp when the air pressure is not applied to the release air port.

11. The insert changeover system of claim 9, wherein, when the air pressure is re-applied to the release air port, the at least one pneumatic pull stock clamp unlocks the portion of the at least one insert guide pin with respect to the body of the at least one pneumatic pull stock clamp.

12. The insert changeover system of claim 1, wherein a body of the at least one pneumatic pull stock clamp includes a lock air port and a release air port.

13. The insert changeover system of claim 12, wherein, when an air pressure is applied to the release air port, the at least one pneumatic pull stock clamp is configured to receive a portion of the at least one insert guide pin within the body of the at least one pneumatic pull stock clamp.

14. The insert changeover system of claim 13, wherein, when an air pressure is applied to the lock air port, the at least one pneumatic pull stock clamp locks the portion of the at least one insert guide pin within the body of the at least one pneumatic pull stock clamp.

15. The insert changeover system of claim 14, wherein, when the air pressure is re-applied to the release air port, the at least one pneumatic pull stock clamp unlocks the portion of the at least one insert guide pin with respect to the body of the at least one pneumatic pull stock clamp.

16. The insert changeover system of claim 1, wherein the mold body includes a mold cavity, and
wherein the insert is disposed in the mold cavity.

17. The insert changeover system of claim 16, wherein a part of the insert is adjacent to a face of the cavity when the insert is disposed in the mold cavity,
wherein the mold body includes a tunnel extending from an opening in the face of the mold cavity to the at least one pneumatic pull stock clamp, and
wherein at least a portion of the at least one insert guide pin extends from the insert into the opening and through the tunnel to the at least one pneumatic pull stock clamp when the insert is disposed in the mold cavity.

18. The insert changeover system of claim 1, wherein the mold body includes a plurality of module plates, and
wherein the at least one pneumatic pull stock clamp is accommodated within at least one of the plurality of module plates.

19. The insert changeover system of claim 1, wherein the at least one pneumatic pull stock clamp includes a plurality of pneumatic pull stock clamps, and
wherein the at least one insert guide pin includes a plurality of insert guide pins.

20. The insert changeover system of claim 19, wherein the at least one pneumatic pull stock clamp includes four pneumatic pull stock clamps, and
wherein the at least one insert guide pin includes four insert guide pins,
wherein each of the four pneumatic pull stock clamps and the four insert guide pins are disposed adjacent a corner of a cavity of the mold body.

21. The insert changeover system of claim 19, wherein the mold body includes a plurality of module plates and at least one of the plurality of module plates includes a plurality of receptacles, and
wherein each of the plurality of pneumatic pull stock clamps is disposed in a receptacle of the plurality of receptacles.

22. The insert changeover system of claim 21, wherein at least one of the plurality of module plates includes a channel connecting at least one of the plurality of receptacles to an exterior of the plurality of module plates.

23. The insert changeover system of claim 8, further comprising an air line coupled to the release air port of the at least one pneumatic pull stock clamp and configured to supply air pressure to the release air port.

24. The insert changeover system of claim 12, further comprising:
a first air line coupled to the release air port of the at least one pneumatic pull stock clamp and configured to supply air pressure to the release air port; and
a second air line coupled to the lock air port of the at least one pneumatic pull stock clamp and configured to supply air pressure to the lock air port.

25. A method of releasably securing the insert of the insert changeover system of claim 1, the method comprising:
applying air pressure to a release air port of a body of the pneumatic pull stock clamp;
inserting a portion of the insert guide pin within the body of the pneumatic pull stock clamp; and
turning off the air pressure to the release air port to lock the portion of the insert guide pin within the body of the pneumatic pull stock clamp.

26. The method of claim 25, further comprising:
re-applying the air pressure to the release air port to unlock the portion of the insert guide pin with respect to the body of the pneumatic pull stock clamp; and
removing the insert guide pin with respect to the body of the pneumatic pull stock clamp to remove the insert from the injection mold.

27. A method of releasably securing the insert of the injection mold of claim 1, wherein a body of the pneumatic pull stock clamp includes a lock air port and a release air port, the method comprising:
applying air pressure to a release air port of a body of the pneumatic pull stock clamp;
inserting a portion of the insert guide pin within the body of the pneumatic pull stock clamp; and
applying an air pressure to the lock air port to lock the portion of the insert guide pin within the body of the pneumatic pull stock clamp.

28. The method of claim 27, further comprising:
re-applying the air pressure to the release air port to unlock the portion of the insert guide pin with respect to the body of the pneumatic pull stock clamp; and
removing the insert guide pin with respect to the body of the pneumatic pull stock clamp to remove the insert from the injection mold.

29. A method of releasably securing the insert of the insert changeover system of claim 1, wherein a body of the pneumatic pull stock clamp includes a lock air port and a release air port, the method comprising:
applying air pressure to a release air port of a body of the pneumatic pull stock clamp to unlock the portion of the insert guide pin with respect to the body of the pneumatic pull stock clamp; and
removing the insert guide pin with respect to the body of the pneumatic pull stock clamp to remove the insert from the injection mold.
